(19) United States
(12) Patent Application Publication
(10) Pub. No.: US 2006/0245989 A1
(43) Pub. Date: Nov. 2, 2006

(54) Monolithic pipe structure particularly suited for riser and pipeline uses

(76) Inventor: Gregory J. Miller, Houston, TX (US)

Correspondence Address: RICHARD A. FAGIN, P.O. BOX 1247, RICHMOND, TX, 77406-1247, US

(21) Appl. No.: 11/370,197

(22) Filed: Mar. 7, 2006

Related U.S. Application Data
(60) Provisional application No. 60/659,584, filed on Mar. 8, 2005.

(51) Int. Cl. B01J 8/02; B01J 35/02

(52) U.S. Cl. 422/211; 422/222

(57) ABSTRACT

A pipe in pipe system includes an outer pipe and an inner pipe disposed within the outer pipe. The inner pipe has a diameter selected to provide an annular space between the inner pipe and the outer pipe. A plurality of circumferentially spaced apart ribs is disposed in the annular space and connects the inner pipe to the outer pipe to form a monolithic structure. The inner pipe and the outer pipe each has a wall thickness less than a single-walled pipe capable of withstanding a selected burst pressure, collapse pressure and bending stress to be applied to the monolithic structure.

### CROSS-REFERENCE TO RELATED APPLICATIONS

Priority is claimed from U.S. Provisional application No. 60/659,584 filed in Mar. 8, 2005.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of pipelines and hydrocarbon production systems. More specifically, the invention relates to structures for pipelines and other fluid transport conduits having improved thermal insulation and strength.

2. Background Art

In subsea hydrocarbon production and transportation systems, various types of transport pipes (“pipelines”) are coupled to equipment at the uppermost end of subsea hydrocarbon producing wellbores drilled through the Earth's subsurface. The pipeline provides a path for fluids produced from the wellbores to various handling and processing devices, which may be on the water surface or may be on the sea floor at a location different from the wellbore. Where such pipelines traverse a substantial path through cold water, such as along the sea floor, and/or from great depth in the ocean to the surface, it is useful to provide some form of thermal insulation between the pipeline and the ocean water outside the pipeline. Thermal insulation reduces the possibility that the produced hydrocarbons will undergo a state change, such as the formation of gas hydrates, or substantial increase in the viscosity of produced crude oil, such that flow of the produced hydrocarbons is hampered or fails. Such state and/or viscosity changes may occur as the produced fluids, which are frequently at elevated temperatures in the subsurface Earth formations from which they are produced, are exposed to the cold temperatures of ocean water through which the pipelines extend.

It is known in the art to provide thermal insulation using so-called “pipe-in-pipe” transport conduit systems. Pipe-in-pipe systems include an inner conduit, usually made from steel or similar high strength (but highly thermally conductive) metal, surrounded by an outer conduit, also typically made from steel. The inner diameter of the outer conduit is selected to provide an annular space between the two conduits. The annular space between the inner conduit and the outer conduit is typically filled with urethane or similar thermal insulator to reduce heat transfer from the inner conduit to the outer conduit. To maintain the relative lateral position of the inner conduit inside the outer conduit, a number of centralizing devices, usually made from steel, are disposed in the annular space at spaced apart locations along the length of the pipe-in-pipe conduit. Together, the centralizers and the urethane provide substantial thermal conductivity between the inner conduit and the outer conduit, even though such conductivity is considerably less than that from a single pipe exposed to the ocean water.

The advent of deep sub-sea drilling created the new challenge of reducing the substantial heat loss in the produced hydrocarbons caused by near freezing temperature water coming in direct contact with the produced-fluid pipeline. Such heat loss led to the development of the sub-sea pipe-in-pipe conduit described above. However, there has been no significant improvement in the thermal insulation quality of pipe-in-pine conduits since they were originally developed. Furthermore, pipe-in-pipe systems known in the art require that the wall thickness of each of the inner pipe and the outer pipe be selected to withstand the full amount of expected burst and collapse pressures expected to be encountered by the pipeline. They must also have sufficient wall thickness in each of the inner pipe and the outer pipe such that each is able to withstand expected bending loads without deforming and subsequently damaging either pipe.

There continues to be a need for pipelines and other fluid conduits that have reduced weight, better thermal insulating properties and increased stiffness and pressure resistance as compared to pipe-in-pipe systems known in the art.

### SUMMARY OF THE INVENTION

One aspect of the invention is a pipe in pipe system. A pipe in pipe system according to this aspect of the invention includes an outer pipe and an inner pipe disposed within the outer pipe. The inner pipe has a diameter selected to provide an annular space between the inner pipe and the outer pipe. A plurality of circumferentially spaced apart ribs is disposed in the annular space and connects the inner pipe to the outer pipe to form a monolithic structure. The inner pipe and the outer pipe each has a wall thickness less than a single-walled pipe capable of withstanding a selected burst pressure, collapse pressure and bending stress to be applied to the monolithic structure.

Other aspects and advantages of the invention will be apparent from the following description and the appended claims.

### BRIEF DESCRIPTION OF THE DRAWINGS

FIG. 1 shows an end view of one embodiment of a monolithic-pipe-in-pipe structure according to the invention.

### DETAILED DESCRIPTION

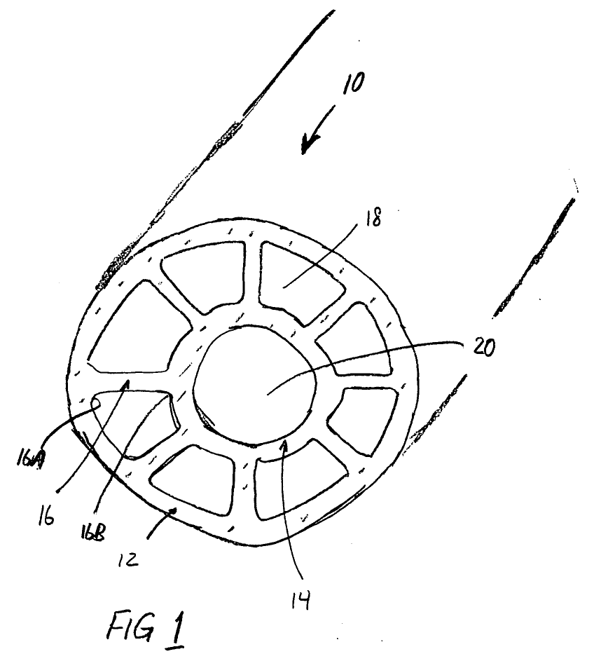

An end view of one embodiment of a monolithic pipe-in-pipe structure according to the invention is shown in FIG. 1. The structure 10 may be extruded as a single component through any metal extruding device known in the art. The monolithic structure 10 may be formed from steel, aluminum or other high strength metal, or from composite materials such as fiber reinforced plastic. The particular metal alloy or material used, and the dimensions of the various parts of the monolithic structure are a matter of choice for the user and are not intended to limit the scope of the invention. Parameters that will affect the metal alloy or material selection and the dimensions used include the external and internal pressures expected on the monolithic structure 10, the weight per unit length requirements of the user, and the extent to which the particular fluids to which the monolithic structure 10 is exposed are reactive with the metal alloy selected.

The monolithic structure 10 includes an outer pipe 12 and an inner pipe 14. The outer pipe 12 and inner pipe 14 may each have a wall thickness substantially less than would ordinarily be required of corresponding pipes in a pipe-in-pipe system known in the art prior to the present invention, or for a single wall pipe. Such prior art outer pipe or single pipe wall thickness would be selected to resist crushing of the outer pipe when exposed to high external (hydrostatic) pressure, and such inner pipe or single pipe wall thickness would be selected to resist bursting due to internal pressure of the fluid carried inside the inner pipe. In the present embodiment, the force of external pressure acting on the outside of the outer pipe 12 is partially transferred through circumferentially spaced apart supporting ribs 16 that connect the inner wall of the outer pipe 12 to the outer wall of the inner pipe 14. Conversely, force exerted on the inner pipe 14 by the pressure of fluid carried in the interior 20 of the inner pipe 14 is partially transferred to the outer pipe 12 through the supporting ribs 16.

As previously explained, the entire monolithic structure 10 shown in FIG. 1 may be extruded as a single component using any extrusion device known in the art. Preferably the supporting ribs 16 are formed to have suitable radiusing features 16A, 16B to make smooth transition from the rib 16 to the outer pipe 12 and inner pipe 14 correspondingly. The radiusing features 16A, 16B reduce the possibility of undue stress concentration at the juncture of the ribs 16 with either the inner pipe 14 or the outer pipe 12. Alternatively, the monolithic structure may be formed from separate pipes 12, 14 and supporting ribs 16.

The ribs 16 are preferably evenly angularly spaced around the circumference. It is anticipated that a minimum number of ribs would be three, spaced circumferentially at about 120 degrees angle from each other. However, having more ribs will increase the effectiveness of force transfer between the inner pipe 14 and the outer pipe 12, thus enabling a corresponding reduction in wall thickness of both the inner pipe 14 and the outer pipe 12. Conversely, the number of ribs and the contact area between the ribs 16 and the inner pipe 14 and outer pipe 12 will affect the thermal conductivity of the monolithic structure 10. Therefore, the number of ribs and their contact area will depend on the particular application for any embodiment of composite structure according to the invention.

Void spaces 18 are defined between the supporting ribs 16. In some embodiments, the void spaces 18 may be evacuated by sealing the longitudinal ends of the monolithic structure 10 and pumping any air or gas from the void spaces 18 using a vacuum pump. By evacuating the void spaces 18, heat transfer by conduction between the inner pipe 14 and the outer pipe 12 is substantially reduced. Such reduction in conductive heat transfer makes it possible to maintain a relatively small difference in diameter between the inner pipe 14 and the outer pipe 12, thus reducing the necessary external diameter of the monolithic structure 10 with respect to the internal diameter of the interior 20 of the inner pipe, while maintaining substantial thermal insulation properties. Such inner diameter 20 is ordinarily selected based on the expected flow therethrough. As contrasted with insulated pipe-in-pipe systems known in the art, for any selected flow capacity in the interior 20, a pipe-in-pipe system may have substantially reduced weight and external diameter, while retaining substantial thermal insulation capacity.

Conversely, the diameter of the outer pipe 12 may be selected to provide an increased displacement volume of the monolithic structure 10 with respect to its weight (effective density), such that the weight of the monolithic structure 10 when submerged in water is substantially reduced or even eliminated.

In one embodiment, a length of pipe having the above described monolithic structure may be formed by extrusion through an appropriately shaped die.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A pipe in pipe system, comprising:
an outer pipe;
an inner pipe disposed within the outer pipe, the inner pipe having a diameter selected to provide an annular space between the inner pipe and the outer pipe;
a plurality of circumferentially spaced apart ribs disposed in the annular space and connecting the inner pipe to the outer pipe to form a monolithic structure; and
wherein the inner pipe and the outer pipe each has a wall thickness less than a single-walled pipe capable of withstanding a selected burst pressure, collapse pressure and bending stress to be applied to the monolithic structure.

2. The system of claim 1 wherein the annular space comprises at least three of the ribs.

3. The system of claim 1 wherein the ribs comprise radiusing features at junctures between the ribs and each of the inner and outer pipes.

4. The system of claim 1 wherein the ribs define void spaces in the annular space, and wherein the void spaces are evacuated.

5. The system of claim 1 wherein a dimension of the annular space is selected to provide a selected weight in water to the monolithic structure.
